(19) United States
(12) Patent Application Publication
(10) Pub. No.: US 2016/0301965 A1
(43) Pub. Date: Oct. 13, 2016

(54) MULTIMEDIA MANAGEMENT SYSTEM FOR CONTROLLING AND MANAGING A VIDEO STREAM

(71) Applicant: OZ ehf, Reykjavik (IS)

(72) Inventors: Gudjon Mar GUDJONSSON, Reykjavik (IS); Olafur Ragnar HELGASON, Reykjavik (IS)

(21) Appl. No.: 15/094,671

(22) Filed: Apr. 8, 2016

Related U.S. Application Data
(60) Provisional application No. 62/144,464, filed on Apr. 8, 2015.

(51) Int. Cl. H04N 21/2668; H04N 21/262; H04N 21/258

(52) U.S. Cl. CPC H04N 21/2668; H04N 21/25841; H04N 21/25883; H04N 21/26283; H04N 21/25891

(57) ABSTRACT

A multimedia management system for controlling and managing a video stream from a collection of videos including a computer system and at least one storage system communicatively connected to a network, in communication with the computer system, to store a collection of videos. A channel stream markup language (CSML) engine is configured to process a CSML schedule template, where the schedule template includes at least one-time slot containing information. An input unit receives input instructions from a channel administrator, via the CSML schedule template, and include selecting at least one video content from the collection of video contents to be aired. The computer system is configured to utilize the CSML schedule template, in accordance to the received input instructions from the channel administrator, to trigger a stream of the at least one video content to be aired.

### FIELD OF THE INVENTION

The present invention relates to a multimedia management system for controlling and managing a video stream from a collection of videos.

### BACKGROUND OF THE INVENTION

Video streaming services like youtube do not offer the possibility of generating a live broadcast stream where programs are scheduled from the channel's video collection. They only allow users to show individual live events and schedule when a particular video on demand (VOD) video will be made publicly available for viewers.

Traditional TV broadcast systems are used to create and manage the broadcast schedule of TV stations. These systems are however not targeted for Internet streaming where video content resides in cloud storage systems. Also, in such traditional TV scheduling systems each program needs to be scheduled exactly with second precision as well as any material related to a program such as introduction, trailers and advertisements shown before, in the middle of, or after the program. These traditional TV systems do not provide the possibility of personalizing the channel schedule to individual users or groups of users; all viewers see the same schedule irrespective of preference, age, country, timezone etc. Finally, these systems are also complex and generally require expert knowledge.

### SUMMARY OF THE INVENTION

It would be advantageous to achieve user friendly system and a method to control and manage video stream from collection of videos, e.g. manage Internet video stream, where programs may be scheduled from a collection of videos in e.g. a cloud storage system, and where the content to be aired may be fully controlled by the user.

In general, the invention preferably seeks to mitigate, alleviate or eliminate one or more of the above mentioned disadvantages singly or in any combination. In particular, it may be seen as an object of the present invention to provide a multimedia system that solves the above mentioned problems, or other problems, of the prior art.

To better address one or more of these concerns, in a first aspect of the invention a multimedia management system is provided for controlling and managing a video stream from a collection of videos, comprising:
a computer system,
at least one storage system communicatively connected to a network, in communication with the computer system, configured to store a collection of videos,
a channel stream markup language (CSML) engine configured to process a CSML schedule template, where the schedule template comprises:
   at least one-time slot containing information about a begin time and end time of the at least one-time slot, and
   content selection data comprising information related to the video content to be displayed in the at least one-time slot,
an input unit configured to receive input instructions from a channel administrator, via the CSML schedule template, the input instructions including selecting at least one video content from the collection of video contents to be aired and in which time slot selected from the at least one time slot to air the at least one selected video, where the computer system is configured to utilize the CSML schedule template, in accordance to the received input instructions from the channel administrator, to trigger a stream of the at least one video content to be aired.

A simple and user friendly way is thus provided for managing a video stream such as, but not limited to, an Internet video stream, whereby e.g. via input from the channel administrator through the CSML schedule template the play-out schedule of the stream may easily be managed. Such managing includes as an example defining what and when a specific video is to be broadcasted or changes in the CSML schedule template where e.g. existing video content may be removed from the CSML schedule template and replaced with new video content.

Accordingly, the multimedia system enables non-experts to create a low cost video channel or a broadcast station where the stream is managed via the CSML schedule template, and where managing the content schedule to be displayed is greatly simplified.

The collection of videos may in one embodiment be stored in a cloud storage system and where triggering the stream of the at least one video content to be aired may be done via a network such as a wireless network.

The at least one-time slot includes plurality of time slots, where e.g. a calendar like platform may be utilized to enter the content selection data.

The CSML schedule template may in one embodiment be a new CSML schedule template. In another embodiment the CSML schedule template is an existing template where at least some of the content selection data in the existing CSML schedule template is replaced with new content selection data.

In one embodiment, the content selection data comprises video identification data (ID) uniquely identifying the video content to be aired. A simple solution is thus provided for specifying which video content to be aired. The video ID can be any type of data, e.g. video_ID_12345, that uniquely identifies the video content to be aired. The video ID may also be understood as being title or even a part of a title of the video to be aired, e.g. the title “Shining”, where the system may be configured to process the entered title, i.e. “Shining”, by e.g. comparing it with the titles of the collection of videos to obtain the video ID. Thus, the channel administrator does not need to enter an abstract ID code, but instead can enter a full title, or part of a title etc.

In one embodiment, wherein the content selection data comprises a selection rule module adapted to receive selection rule commands from the channel administrator for managing the video channel schedule via the CSML schedule template.

In one embodiment, the selection rule commands comprise at least one of the following:
video genre,
video category,
metadata associated to the video content.

Accordingly, a simple and a user friendly solution is provided for selecting the video content to be aired. The selection rule could as an example include playing videos/movies with “Chuck Norris” (i.e. metadata may be a text string with the name of the actor), or the selection rule could be the video genre “music videos”, where even more specific definition of music videos may be included such as 90's disco via e.g. the metadata.

Another example of selection rule could include playing horror movies (e.g. between 01:00-05:00 AM) where the genre may specify the type of video/movie to be played and in which time frame the video is allowed to be played.

The selection rule commands may in another example include detailed information related to the content information such as in which countries a video content is allowed to be aired, and which countries the video content is not allowed to be aired due to e.g. license issues.

In one embodiment, the multimedia management system further comprises a subscriber module adapted to receive subscriber requests from users requesting an access to the stream of the at least one video content to be aired as defined in the CSML schedule template, where the subscriber requests include information about the users including information about the geographical location of the users and/or the age of the users, and where the selection rule module is configured to utilize the information about the users in managing and adapting the stream of the at least one video content to each individual user.

Accordingly, it is possible to e.g. adapt the video stream to the geographical location of the users and/or the age of the users. As an example, and as already addressed, at one location/country a given TV show may be licensed and thus it may not be permitted to broadcast this TV show at this location, and where instead another TV show may be broadcasted there instead, where this other TV show may be defined via the selection rule module. Thus, IP license rights may be honored at these locations fully automatically.

Also, the videos (e.g. TV shows, movies etc.) may in some instances be prohibited below certain age range (i.e. PG-rated) meaning that the system is capable of adapting the video content to the age of the users fully automatically by prohibiting the video content and e.g. replace the video content with another allowable video content within this given time slot.

In one embodiment, the multimedia management system further comprises a history tracking module configured to capture users viewing history data, where the tracking history is configured to utilized the viewing history data as input in adapting the stream of the at least one video content to be aired to each individual user.

Accordingly, it is possible to adapt the video content to be aired to each individual user based on what the user has watched and not. As an example, two different users that may have a subscription to the same may be watching different video content within the same time slot, although e.g. the users are located within the same time zone, as defined by the CSML schedule template. This may be the case if the content to be aired within e.g. the time slot 8-9 PM is the series “Friends” where one of the two users has watched more episodes than the other users, where the series number and the number of episodes within each series is monitored by the history tracking module. Thus, one of the two users may be in episode 3 in series 5 of Friends, whereas the other user is in episode 2 of series 1 of Friends. Another example is where a time slot in the CSML schedule template specifies that a horror movie is to be aired between 01:00-03:00 AM, and where the system may select two different horror movies for the two users because their viewing history is different. Thus, one of the users may be assigned to the movie “Alien”, whereas the other user may be assigned to the movie “Shining”, i.e. both of the movies are however within the same movie category.

The same may apply if the video to be played is with a specific actor, but where one of the users has already seen the selected movie with this user, the history tracking module can automatically select another movie with this same actor.

In a second aspect of the invention a method is provided of managing a multimedia management system for controlling and managing a video stream from a collection of videos, the multimedia management system comprising:
a computer system,
at least one storage system communicatively connected to a network, which in communication with the computer system, is configured to store a collection of videos,
a channel stream markup language (CSML) engine configured to process a CSML schedule template comprising at least one-time slot containing information about a begin time and end time of the at least one-time slot, the CSML schedule template further comprising content selection data comprising information related to the video content to be displayed in the at least one-time slot,
   wherein the method comprises:
receiving input instructions from a channel administrator, via the CSML schedule template, the input instructions including selecting at least one video content selected from the collection of video contents to be aired and in which time slot selected from the at least one-time slot to air the at least one selected video,
utilizing by the computer system the CSML schedule template, in accordance to the received input instructions from the channel administrator, to trigger a stream of the at least one video content to be aired.

Accordingly, a method is provided that enables e.g. individuals, smaller companies, to create their own channel, a kind of a TV station, without much effort and cost where only a limited expert knowledge is required.

In one embodiment, the step of receiving the input instructions from the channel administrator comprises receiving selection rule commands comprising at least one of the following:
a full or part of a title of a video content to be displayed,
video genre,
video category,
metadata associated to the video content.

A user friendly way is thus provided to enter the video content data into the CSML schedule template, where e.g. the video content data does not necessarily have to include detailed data about the title of the video content, but may e.g. only contain video genre, e.g. music videos etc.

In one embodiment, the method further comprises monitoring via a history tracking module the video content so as to capture users viewing history data, where the viewing history data is utilized for personalizing the stream of the at least one video content to be aired to each individual user. It is thus possible to e.g. avoid that the video content that is to be aired within a given time slot has already been watched by the user.

In one embodiment, the step of triggering the stream of the at least one video content to be aired is limited to users being subscribers to the CSML schedule template. The subscription could include payment to the access of the CSML schedule template, e.g. a monthly payment.

In one embodiment, the method further comprises providing the users with a preview access to the video content defined in the CSML schedule template. Accordingly, a commercially favorable tool is provided that may encourage users to be subscribers to channels. A given channel may as an example be focused on action movies, whereas another channel may be more music oriented, or e.g. have focus on old movies etc. In that way, the users may be provided with a preview access to different channels to find the most suitable channel.

In one embodiment, step of triggering the stream of the at least one video content to be aired is personalized to each individual user based on at least one of the information:
data indicating the age of the user,
data indicating the time zone of the geographical location of the user,
data indicating the gender of the user,
data indicating the historical background of the user,
data indicating the language skill of the user,
data indicating the educational background of the user, and
data indicating the marital status of the user.

Accordingly, the at least one video content to be aired may be highly personalized to each individual user, based on e.g. their geographical location, and/or the gender of the user, and/or the educational background of the user and/or the marital status etc. Thus, although a number of users are subscribers to a channel the content that is being aired (or is to be aired) may be different due to the above mentioned data. This may be due to different geographical location due to e.g. different time zones, or due to different interests/background/age of the users, where e.g. within a given time slot in the CSML schedule template different content may be aired. If the content definition within the time slot is comedy as an example, different type of comedies may be selected, e.g. due to different age of the users, or due to different viewing history, and/or due to different language skills, where a user that is well familiar with Italian may be presented with an Italian comedy.

In a third aspect of the invention a computer readable medium is provided for storing computer readable program code embodied therein for managing a multimedia management system for controlling and managing a video stream from a collection of videos, the multimedia management system comprising:
a computer system,
at least one storage system communicatively connected to a network, which in communication with the computer system, is configured to store a collection of videos,
a channel stream markup language (CSML) engine configured to process a CSML schedule template comprising at least one-time slot containing information about a begin time and end time of the at least one-time slot, the CSML schedule template further comprising content selection data comprising information related to the video content to be displayed in the at least one-time slot,
   wherein the computer readable medium is configured to:
receive input instructions from a channel administrator, via the CSML schedule template, the input instructions including selecting at least one video content selected from the collection of video contents to be aired and in which time slot selected from the at least one-time slot to air the at least one selected video,
utilize by the computer system the CSML schedule template, in accordance to the received input instructions from the channel administrator, to trigger a stream of the at least one video content to be aired.

In general, the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which:

FIG. 1 depicts one embodiment of a multimedia management system according to the present invention for controlling and managing a video stream from a collection of videos,

FIG. 2 shows one embodiment of an input unit where a channel administrator enters the CSML engine discussed in relation to FIG. 1,

FIGS. 3-6 depict one embodiment of a subscription module where users, e.g. users in FIG. 1, undergo to be subscribers to a given channel,

FIG. 7 depicts a block diagram of one embodiment of the system according to the present invention for creating a channel,

FIGS. 8-14 depict one type of platform or interface for CSML schedule template,

FIGS. 15 and 16 depict one example of a user interface that may appear in the computing device, and

FIG. 17 depict a flowchart of one embodiment of a method according the present invention of managing a multimedia management system as discussed in relation to FIG. 1.

### DESCRIPTION OF EMBODIMENTS

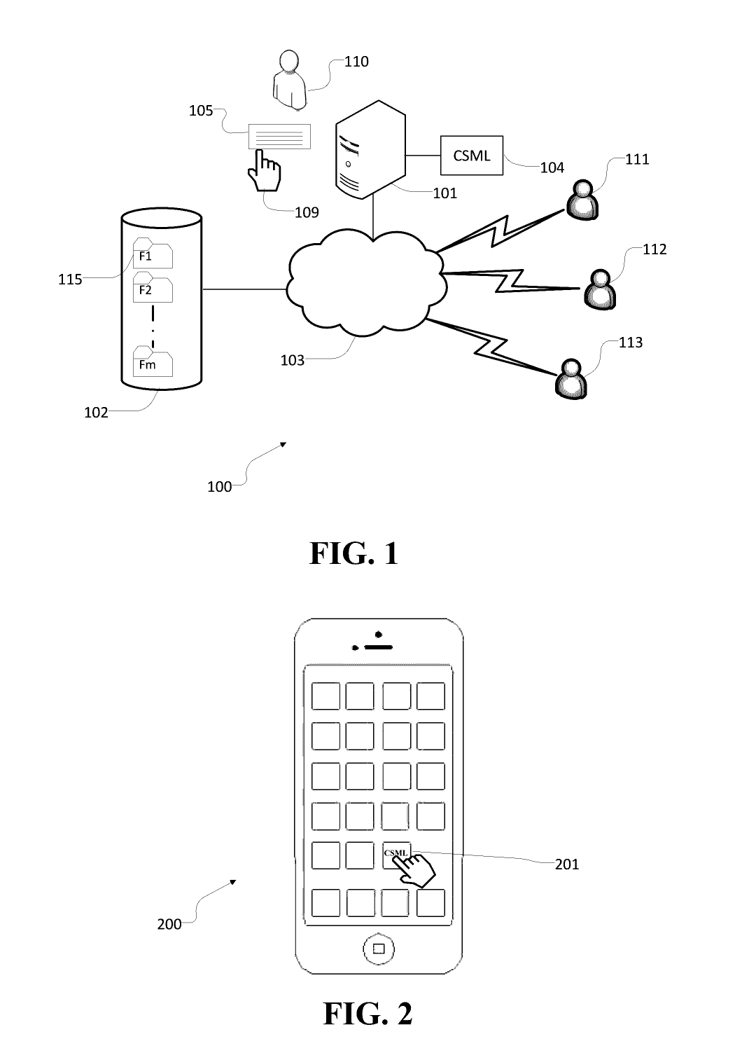

FIG. 1 depicts one embodiment of a multimedia management system 100 according to the present invention for controlling and managing a video stream from a collection of videos 115. The multimedia management system 100 comprises a computer system 101, at least one storage system 102, a channel stream markup language (CSML) engine 104 and an input unit 105.

The at least one storage system 102 is communicatively connected to a network 103, in communication with the computer system 101, and is configured to store a collection of videos 115. The networks may be any type of wired or wireless network such as the Internet.

The CSML engine is configured to process a CSML schedule template. As will be discussed in more details later the schedule template comprises at least one-time slot containing information about a begin time and end time of the at least one-time slot, and content selection data comprising information related to the video content to be displayed in the at least one-time slot.

The input unit 105 may be a PC computer, or any type of computer device such as tablet, mobile phone and the like, and is configured to receive input instructions from a channel administrator 110, via the CSML schedule template. As shown here, this may be done via keyboard commands 109 from the channel administrator, or via any other means, e.g. speech commands, touch commands and the like. The input instructions include selecting at least one video content from the collection of video contents 115 to be aired and in which time slot selected from the at least one-time slot to air the at least one selected video. The computer system is configured to utilize and process the CSML schedule template, in accordance to the received input instructions from the channel administrator, to trigger a stream of the at least one video content to be aired.

In one embodiment, the content selection data comprises video identification data (ID) uniquely identifying the video content to be aired. In another embodiment, the content selection data comprises a selection rule module adapted to receive selection rule commands from the channel administrator for managing the scheduling template of the CSML schedule template, where the selection rule commands comprise at least one of the following: video genre, video category, metadata associated to the video content.

After inputting information in the CSML schedule template the video stream may be aired to different users 111-113 that may e.g. be subscribers to the channel schedule, generated from the CSML template via a subscriber module. This will be discussed in more details later.

The video stream schedule generated from the CSML schedule template may be considered as a video channel or a broadcast station. As an example, this CSML schedule template may primarily be focused on action movies, and where the users 111-113 all have in common being fans of action movies.

Other channels may be created with different CSML schedules template with different content focus, e.g. other channels may be primarily focused on old movies, or music videos etc.

The channels may also of course be a mix of content, e.g. news, sport, movies etc, similar as conventional TV stations.

In one embodiment, the system 100 may further comprise a history tracking module configured to capture users 111-113 viewing history data, where the tracking history is configured to utilized the viewing history data as input in adapting the stream of the at least one video content to be aired to each individual user. In that way, it may be prevented that e.g. a movie or an episode that a given user has seen is presented to this user. Thus, the users 111-113 that are e.g. subscribers to the same channel may be presented with different content within the same time slot due to the viewing history.

In one embodiment, the system 100 is further configured to adapt the timing of the content defined in the CSML schedule template to time at the geographical location of the users 111-113, i.e. content within a given time slot, e.g. 14-15 PM, is always aired at this time within this geographical location.

FIG. 2 shows one embodiment of an input unit 200 where a channel administrator enters the CSML engine discussed in relation to FIG. 1 via mobile phone simply by clicking on an CSML icon on the phone.

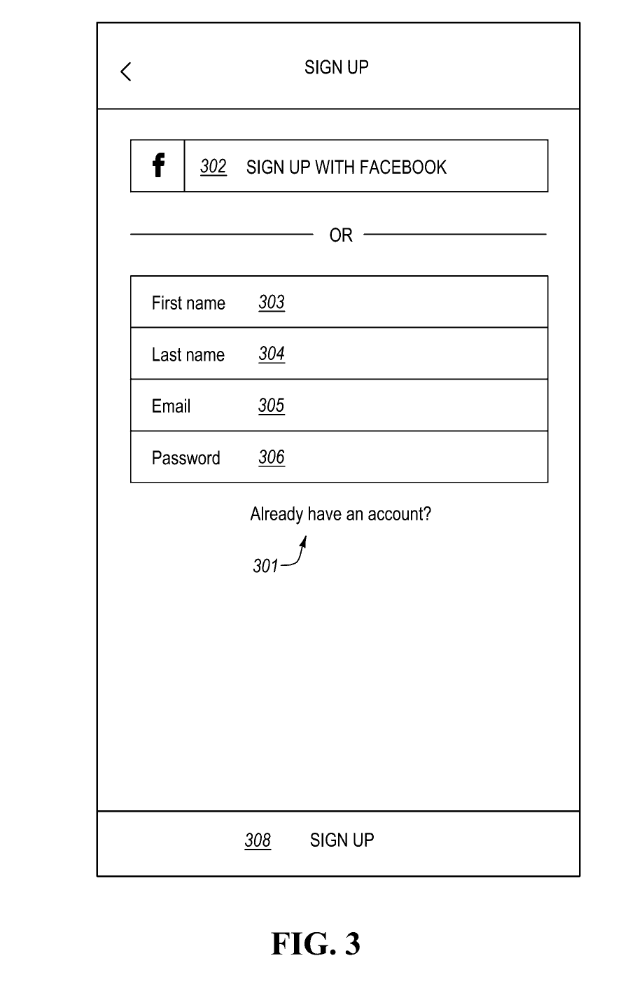

FIGS. 3-6 depict one embodiment of a subscription module where users, e.g. users 111-113 in FIG. 1, undergo to be subscribers to a given channel.

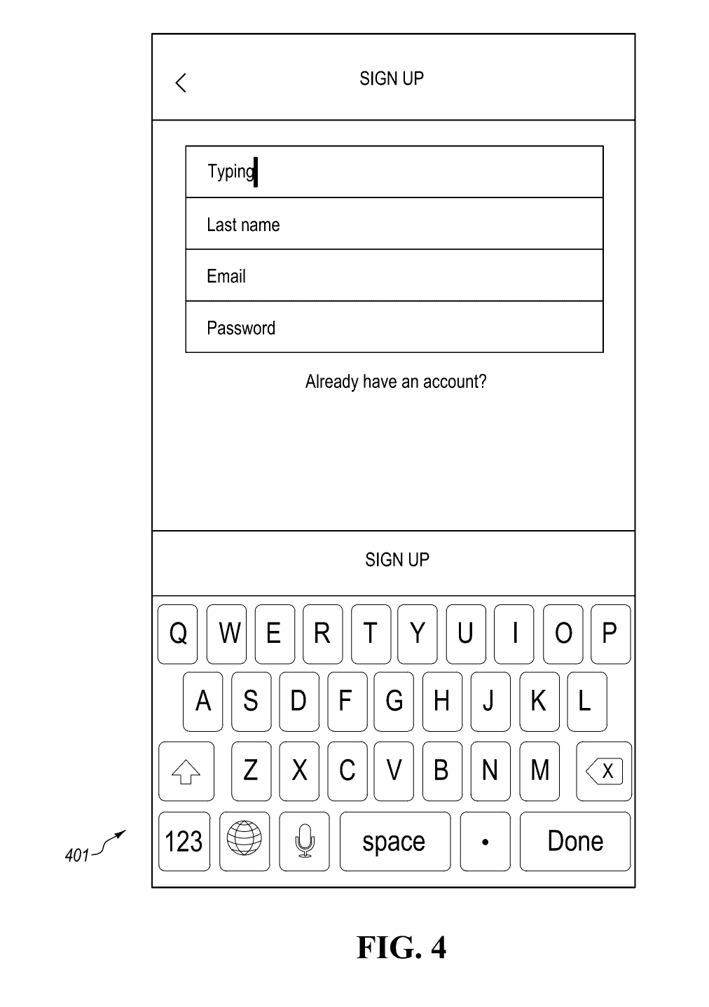

In FIG. 3, the user is asked whether he/she already has an account 301, where via an existing account the user may log into a given channel. In case the user is not yet a subscriber to the channel the user may subscribe via existing Facebook® account 302 (or e.g. any other type of account such as Twitter®), or by entering the first name 303, the last name 304, email address 305 and password 306, and subsequently enter sign up 308, whereby entering one of these fields a keyboard 401 appears as shown in FIG. 4 that allows the user to enter the information.

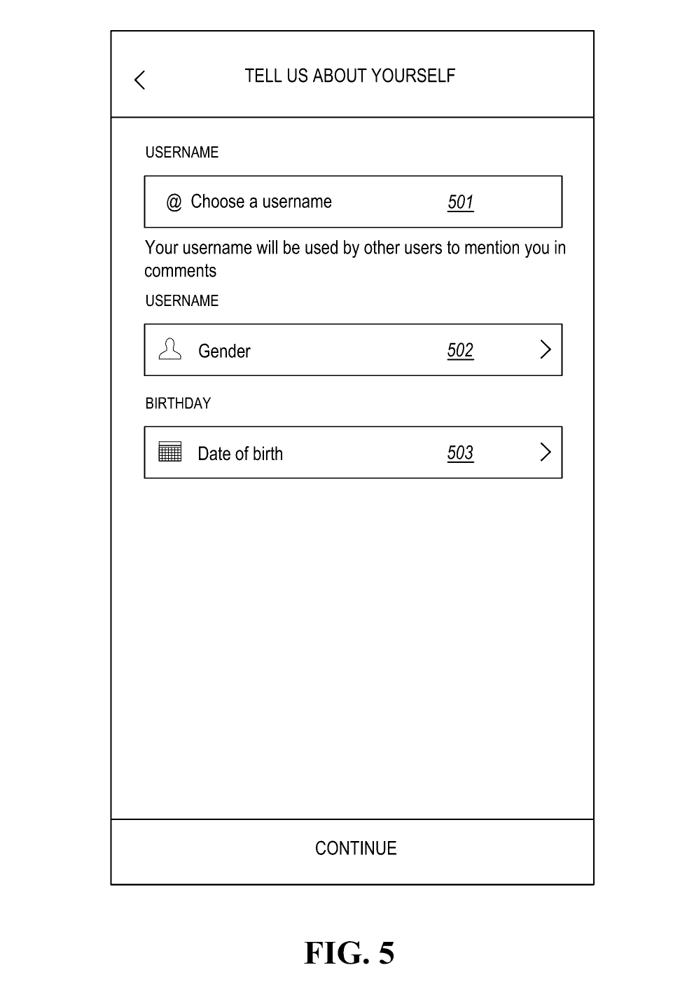

FIG. 5 shows a subsequent step where another interface appears where the user may select a user name 501, enters information about the gender 502 and date of birth 503.

Further information may be requested (not shown) such as hobbies, education level, language skills etc.

Payment information may also be requested (not shown here), e.g. credit card info, Paypal info etc.

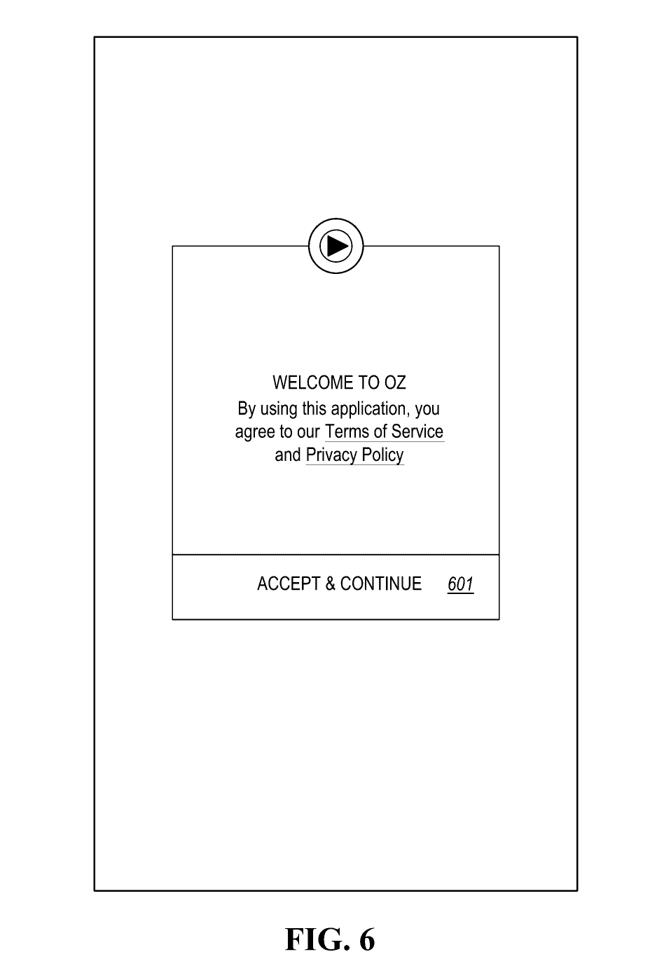

FIG. 6 shows an example of an interface that may appear after the user has entered all the above mentioned information confirming that the user has successfully subscribed to the channel, where the user may confirm terms and conditions by selecting accept and continue 601.

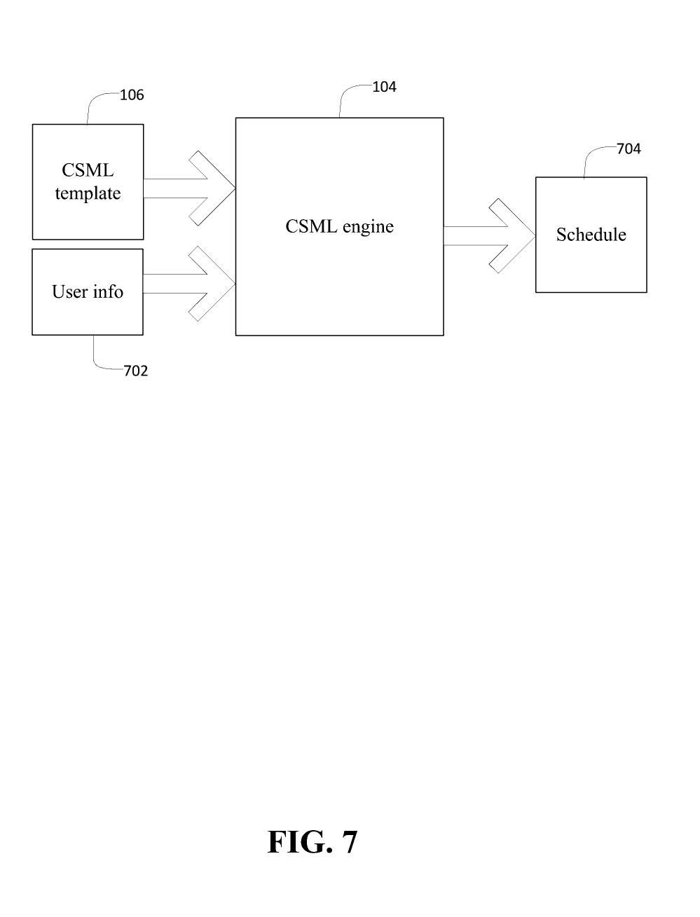

FIG. 7 depicts a block diagram of one embodiment of the system according to the present invention for creating a channel schedule, which may e.g. be any type of Internet broadcast station.

As already discussed, and as will be discussed in more details later, the channel administrator defines the video content to be aired via the CSML schedule template 106, where the type of video content is entered for given time slots.

More importantly, the information about the user 702 as discussed in relation to FIGS. 3-6 is also utilized as input data for the CSML engine 104. The users info 702 may as an example include data indicating the age of the user, data indicating location and thus the time zone of the geographical location of the user, data indicating the gender of the user, data indicating the historical background of the user, data indicating the language skill of the user, data indicating the educational background of the user, and data indicating the marital status of the user. This information is highly relevant for personalizing the video content to be aired such that the selected video content fits to the users profile data. As an example, the CSML schedule template 106 does not necessarily need to specify the exact content, but the type of content, e.g. via genre, the type of content may be selected, and where based on the users information and preferably also the users viewing history, the most suitable video content is selected in the schedule 704.

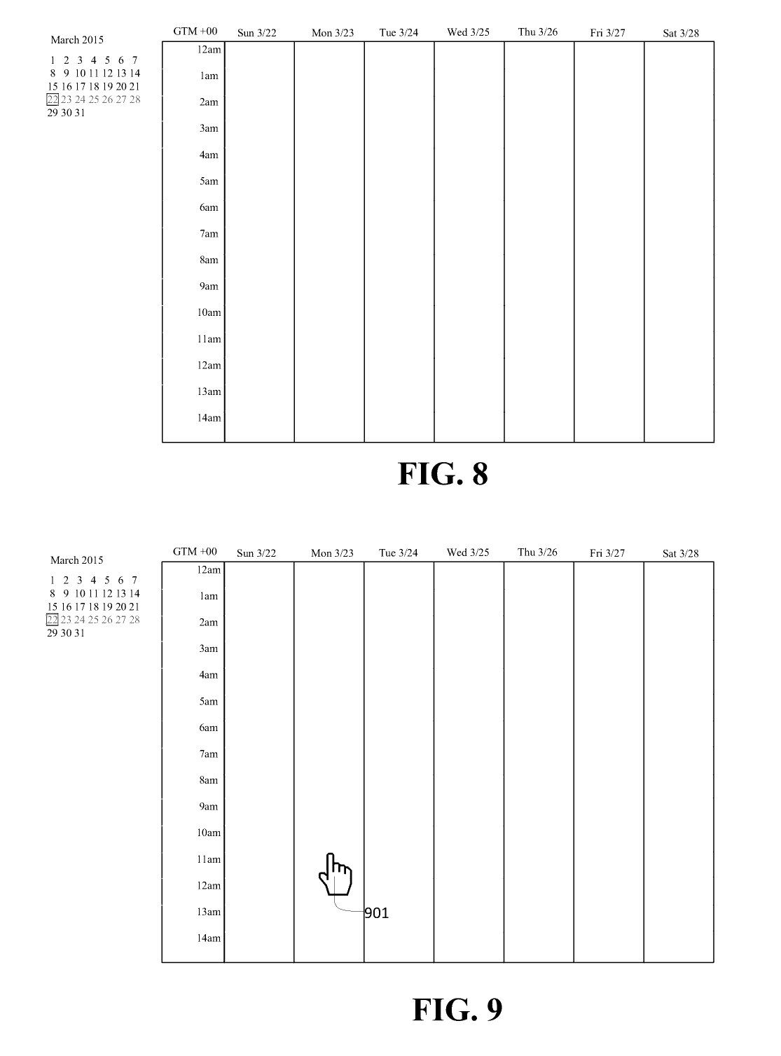

FIG. 8-14 depict one type of platform or interface for CSML schedule template, where the platform has a calendar like interface as shown in FIG. 8, and where the user may as shown in FIG. 9 via touch button command select a given time slot, in this case between 9-10 am.

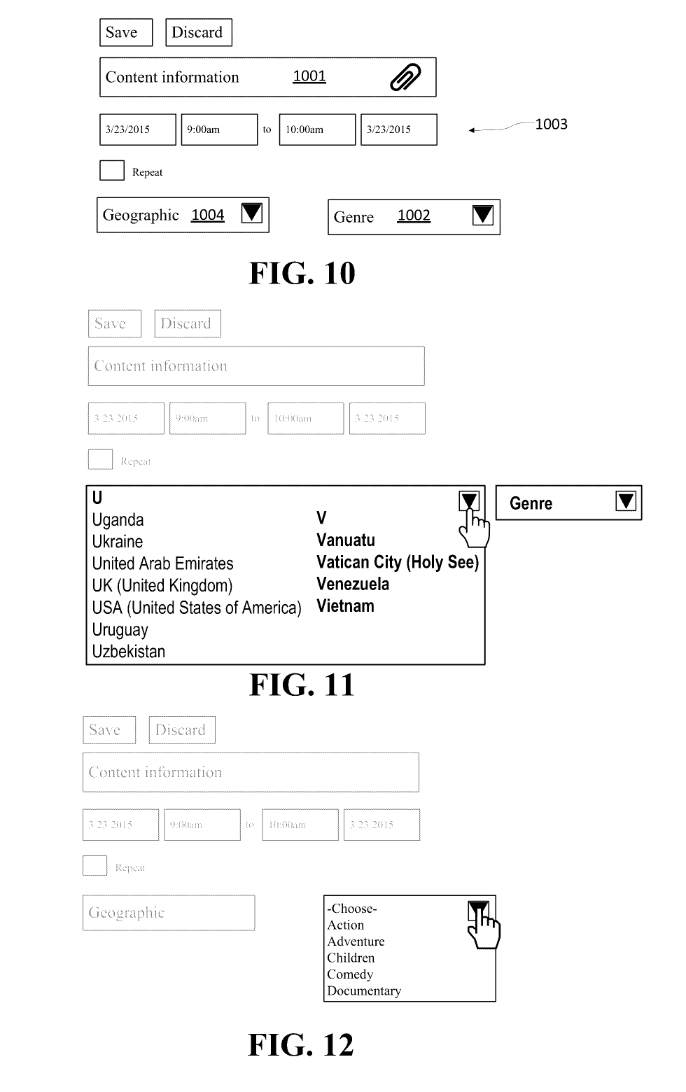

FIGS. 10-14 depict graphically the interface that appears to the user after selecting the time slot 9-10 am, where the data and the time slot appears automatically in field 1003.

The content selection data may comprise video identification data (ID) entered manually by the channel administrator in the field 1001, or the channel administrator may select the content as attachment. The content selection data may also comprise a selection rule module comprising “genre” 1002 where the user may for the selected time slot select the type of video.

The graphical platform shown here should of course not be construed as being limited to the data shown here, where e.g. the field “Geographic” may be dropped, but this field may be of relevance in selecting in which countries or continents the video content is to be aired, or in which countries or continents the video shall not be aired due to e.g. license issues.

FIG. 11 shows where the channel administrator select the field geographic, and FIG. 12 shows where the channel administrator selects the field genre, where the type of videos may be selected, e.g. action, adventure, children etc. As an example, the channel administrator may both enter a title or attach a video title, e.g. “Shining”, and additionally select the genre horror movie. Both these field may be operable connected such that in case a user has already seen the movie shining via the viewing history data may the system may be configured to automatically select another horror movie that the user has not yet seen based on the viewing history data.

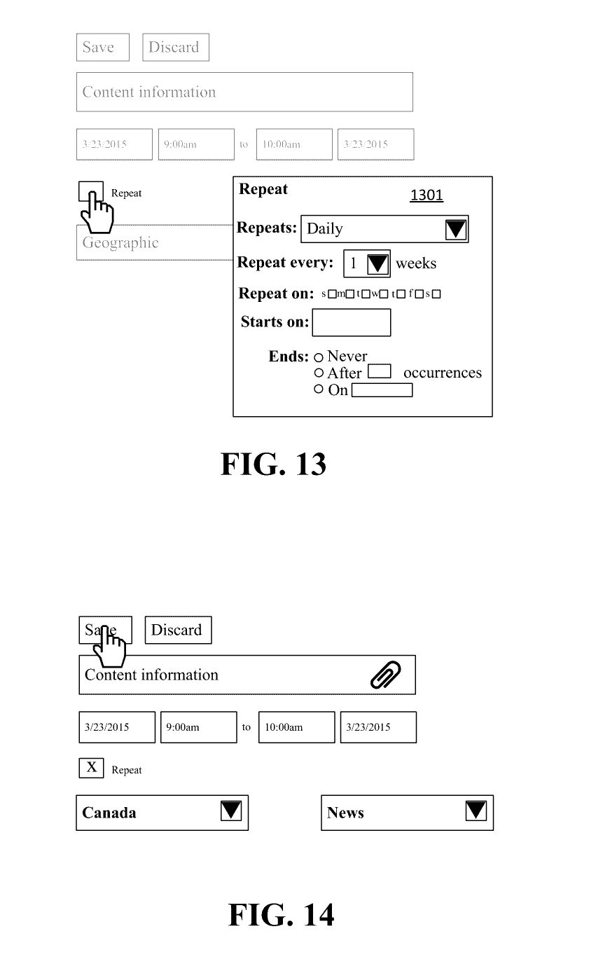

FIG. 13 shows where the channel administrator enters the repeat 1301of the selected content/video, i.e. whether the selected content is to be aired e.g. daily or every week etc.

All this information is converted into suitable format for the multimedia management system for processing the information in the CSML schedule template.

In FIG. 14 the channel administrator saves the entered information and thus confirms that CSML schedule template. The channel administrator may of course perform the steps shown in FIGS. 8-14 in several steps, where a new CSML schedule template is being created or where an existing CSML schedule template is being amended.

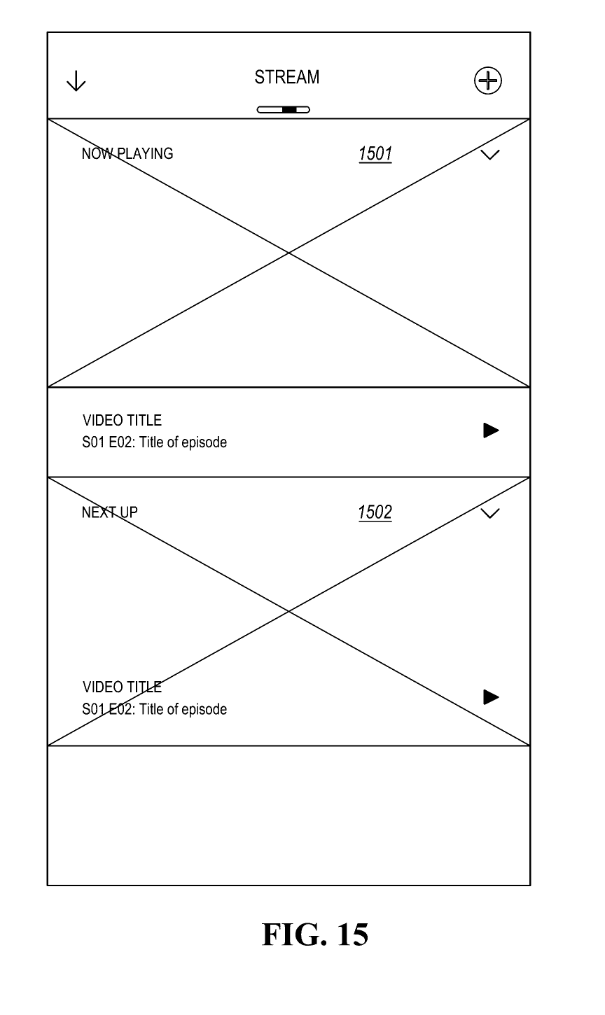

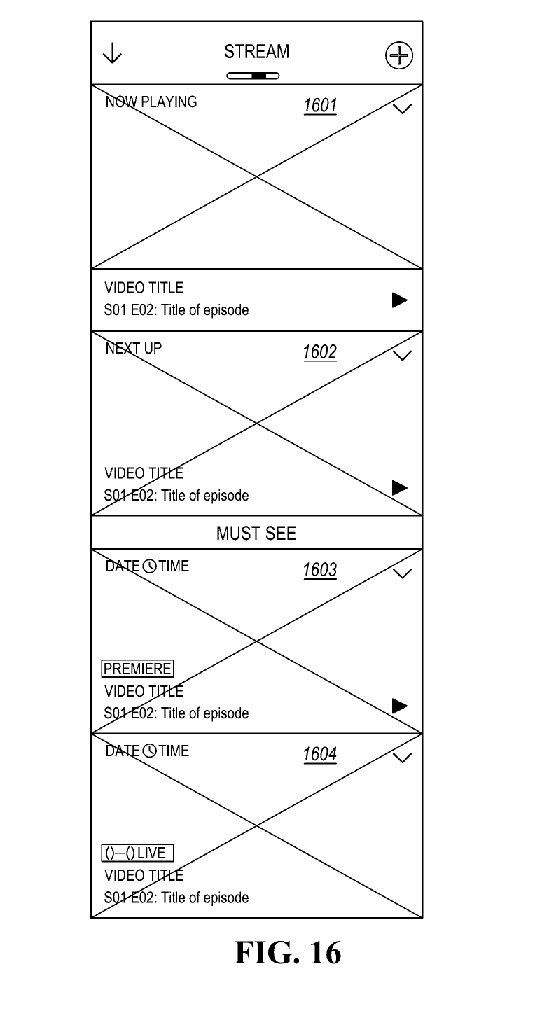

FIGS. 15 and 16 depict one example of a user interface that may appear in the computing device, e.g. the mobile phone shown in FIG. 2, when the user enters the subscriber channel. In FIG. 15 the user is presented with a video that is currently being played 1501 and what video will play next (next up) 1502, and where FIG. 16 shows similarly the video currently being played 1601, the video next up 1602 and with forth coming video titles 1603-1604. The user may as an example via touch or sliding command scroll back and forth on the screen when viewing the channel that the user has a subscription to.

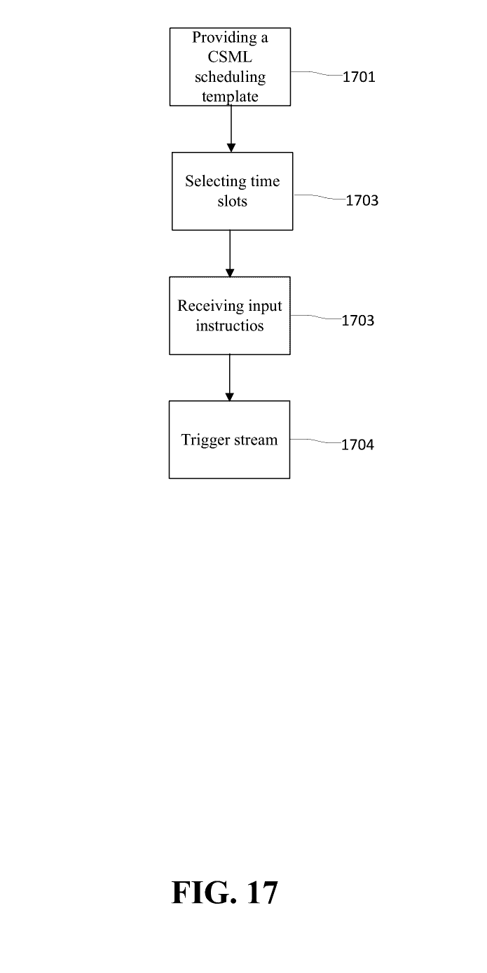

FIG. 17 depicts a flowchart of one embodiment of a method according the present invention of managing a multimedia management system as discussed in relation to FIG. 1 for controlling and managing a video stream from a collection of videos.

In a first step 1701, a CSML scheduling template is provided, which may be performed via a platform as discussed in relation to FIGS. 8-14.

In a second step 1702, time slots are selected by a channel administrator, e.g. similarly as discussed in relation to FIGS. 8-14 where video content and/or genre etc is selected.

In a third step 1703, input instructions are received from a channel administrator, via the CSML schedule template, where the input instructions include selecting at least one video content selected from the collection of video contents to be aired and in which time slot selected from the at least one-time slot to air the at least one selected video.

In a fourth step 1704, the computer system utilizes the CSML schedule template, in accordance to the received input instructions from the channel administrator, to trigger a stream of the at least one video content to be aired.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A multimedia management system for controlling and managing a video stream from a collection of videos, comprising:
a computer system,
at least one storage system communicatively connected to a network, in communication with the computer system, configured to store a collection of videos,
a channel stream markup language (CSML) engine configured to process a CSML schedule template, where the schedule template comprises:
at least one-time slot containing information about a begin time and end time of the at least one-time slot, and
content selection data comprising information related to the video content to be displayed in the at least one-time slot,
an input unit configured to receive input instructions from a channel administrator, via the CSML schedule template, the input instructions including selecting at least one video content from the collection of video contents to be aired and in which time slot selected from the at least one time slot to air the at least one selected video, where the computer system is configured to utilize the CSML schedule template, in accordance to the received input instructions from the channel administrator, to trigger a stream of the at least one video content to be aired.

2. The multimedia management system according to claim 1, wherein the content selection data comprises video identification data (ID) uniquely identifying the video content to be aired.

3. The multimedia management system according to claim 1, wherein the content selection data comprises a selection rule module adapted to receive selection rule commands from the channel administrator for managing the video channel schedule via the CSML schedule template.

4. The multimedia content according to claim 3, wherein the selection rule commands comprise at least one of the following:
video genre,
video category,
metadata associated to the video content.

5. The multimedia management system according to claim 3, further comprising a subscriber module adapted to receive subscriber requests from users requesting an access to the stream of the at least one video content to be aired as defined in the CSML schedule template, where the subscriber requests include information about the users including information about the geographical location of the users and/or the age of the users, and where the selection rule module is configured to utilize the information about the users in managing and adapting the stream of the at least one video content to each individual user.

6. The multimedia management system according to claim 1, further comprising a history tracking module configured to capture users viewing history data, where the tracking history is configured to utilized the viewing history data as input in adapting the stream of the at least one video content to be aired to each individual user.

7. A method of managing a multimedia management system for controlling and managing a video stream from a collection of videos, the multimedia management system comprising:
a computer system,
at least one storage system communicatively connected to a network, which in communication with the computer system, is configured to store a collection of videos, a channel stream markup language (CSML) engine configured to process a CSML schedule template comprising at least one-time slot containing information about a begin time and end time of the at least one-time slot, the CSML schedule template further comprising content selection data comprising information related to the video content to be displayed in the at least one-time slot,
wherein the method comprises:
receiving input instructions from a channel administrator, via the CSML schedule template, the input instructions including selecting at least one video content selected from the collection of video contents to be aired and in which time slot selected from the at least one-time slot to air the at least one selected video,
utilizing by the computer system the CSML schedule template, in accordance to the received input instructions from the channel administrator, to trigger a stream of the at least one video content to be aired.

8. The method according to claim 7, wherein the step of receiving the input instructions from the channel administrator comprises receiving selection rule commands comprising at least one of the following:
a full or part of a title of a video content to be displayed,
video genre,
video category,
metadata associated to the video content.

9. The method according to claim 7, further comprising monitoring via a history tracking module the video content so as to capture users viewing history data, where the viewing history data is utilized for personalizing the stream of the at least one video content to be aired to each individual user.

10. The method according to claim 7, wherein the step of triggering the stream of the at least one video content to be aired is limited to users being subscribers to the CSML schedule template.

11. The method according to claim 7, further comprising providing the users with a preview access to the video content defined in the CSML schedule template.

12. The method according to claim 7, wherein step of triggering the stream of the at least one video content to be aired is personalized to each individual user based on at least one of the information:
data indicating the age of the user,
data indicating the time zone of the geographical location of the user,
data indicating the gender of the user,
data indicating the historical background of the user,
data indicating the language skill of the user,
data indicating the educational background of the user, and
data indicating the marital status of the user.

13. A computer readable medium storing computer readable program code embodied therein for managing a multimedia management system for controlling and managing a video stream from a collection of videos, the multimedia management system comprising:
a computer system,
at least one storage system communicatively connected to a network, which in communication with the computer system, is configured to store a collection of videos, a channel stream markup language (CSML) engine configured to process a CSML schedule template comprising at least one-time slot containing information about a begin time and end time of the at least one-time slot, the CSML schedule template further comprising content selection data comprising information related to the video content to be displayed in the at least one-time slot,
wherein the computer readable medium is configured to:
receive input instructions from a channel administrator, via the CSML schedule template, the input instructions including selecting at least one video content selected from the collection of video contents to be aired and in which time slot selected from the at least one-time slot to air the at least one selected video,
utilize by the computer system the CSML schedule template, in accordance to the received input instructions from the channel administrator, to trigger a stream of the at least one video content to be aired.
